(19) United States
(12) Patent Application Publication
(10) Pub. No.: US 2012/0076896 A1
(43) Pub. Date: Mar. 29, 2012

(54) SPORTS BEVERAGES CONTAINING CARBOHYDRATES

(76) Inventors: Jörg Kowalczyk, Eisenberg/Steinborn (DE); Stephan Hausmanns, Wiesbaden (DE)

(21) Appl. No.: 13/245,781

(22) Filed: Sep. 26, 2011

Related U.S. Application Data
(63) Continuation of application No. 12/296,871, filed on Oct. 10, 2008, now abandoned.

(30) Foreign Application Priority Data
Apr. 12, 2006 (DE) 10 2006 017 611.1

(51) Int. Cl. A23L 2/52; A23L 1/304; A23L 1/302; A23L 2/02; A23L 2/66; A23L 2/56; A23L 2/68; A23L 2/38; A23L 2/60

(52) U.S. Cl. 426/72; 426/590; 426/74

(57) ABSTRACT

The present invention relates to functional beverages containing carbohydrates, containing at least one protein hydrolysate and isomaltulose and the use of isomaltulose and/or leucrose in a functional beverage containing protein hydrolysate.

The present invention relates to functional beverages containing carbohydrates, at least one protein hydrolysate and at least one sucrose isomer selected from isomaltulose and leucrose as well as the uses of isomaltulose and/or leucrose in a functional beverage containing carbohydrate.

Functional beverages such as energy beverages, sports beverages, fitness beverages or even soft drinks are enjoying increasing popularity. Due to their special composition, such beverages not only serve the purpose of supplying fluid but also supply the body with food supplements or performance-enhancing agents, for example. WO 2003/017788 discloses soft drinks or sports beverages containing plant extracts and isomaltulose. These beverages are characterized by a refreshing taste. WO 2004/084655 A1 discloses soft drinks, energy beverages or sports beverages containing isomaltulose and trehalose, which are advantageous inasmuch as they lead to a reduced glycemic reaction in the body of the consumer.

Functional beverages containing protein are also known. However, in many cases they are characterized by poor digestibility and a taste that is often perceived as unpleasant by the consumer. Therefore, there has been a steady demand for other functional beverages which are characterized on the one hand by functionality with respect to restoring and increasing the physical endurance of the consumer but on the other hand are also characterized by a comparatively inexpensive production and in particular by a taste perceived as pleasant by the consumer. In addition, the beverage should be visually attractive, i.e., it should be as clear as possible and should remain stable in storage.

The present invention solves the technical problem on which it is based by providing a functional beverage that contains carbohydrate and at least one protein hydrolysate which is dissolved in a liquid medium and at least one sucrose isomer which has a low glycemic index in comparison with sucrose and is selected from the group consisting of isomaltulose and leucrose. In addition to the protein hydrolysate, the inventive beverage therefore contains either a) isomaltulose or b) leucrose or c) isomaltulose and leucrose. If leucrose and isomaltulose are present jointly in the beverage in an inventive embodiment of the present invention, this may preferably be the case in a ratio of leucrose to isomaltulose of 1:99 wt % to 99:1 wt %, in particular from 30:70 wt % to 70:30 wt % (each based on the total dry solids content of the two isomers).

In conjunction with the present invention, a functional beverage is understood to be a beverage which is also capable of having at least one additional physiological function in the consumer's body in addition to fulfilling the function of meeting the fluid needs of the consumer, namely in particular fulfilling a physiological function with respect to maintaining or improving the physical condition, in particular the health condition, of the consumer. Such functional beverages may therefore in particular be beverages which are used in particular to improve muscle tone, prevent muscle damage, eliminate muscle damage, compensate for increased energy demand, compensate for increased demand for minerals or vitamins, improve fat metabolism, prevent or treat diseases, in particular all of this taking into account the smallest possible increase in blood sugar level, i.e., having the lowest possible glycemic index.

The present invention surprisingly provides a functional beverage that contains carbohydrate and because of the presence of a protein hydrolysate advantageously ensures the creation, regeneration and/or restoration of muscle force and/or prevention of muscle damage. This advantageous anabolic effect of the inventive beverage makes it especially advisable for the elderly, women, obese people, athletes and other people needing a special diet. In addition, an immunostimulating effect is surprisingly manifested, possibly due to the presence of certain amino acid sequence or oligopeptide sequences in the protein hydrolysate that is used. Isomaltulose, 6-O-α-D-glucopyranosyl-fructose (also known as Palatinose®) is a sweetening agent which has approximately half the sweetening power of sucrose. It is also used in special foods for athletes to maintain the oxidative metabolism to some extent because of the delayed degradation of isomaltulose, which occurs only in the area of the small intestine. Isomaltulose is degraded with a time lag by the glucosidases present in the human intestinal wall so the resulting degradation products glucose and fructose are absorbed. This results in a slow increase in blood glucose level in comparison with rapidly digestible carbohydrates. Therefore, in contrast with rapidly digestible high-glycemic substances, isomaltulose requires hardly any insulin for its metabolism. Therefore, the use of isomaltulose in the inventive beverage containing carbohydrates advantageously makes this beverage a low glycemic beverage that combines the advantages of a beverage which provides an excellent amino acid supply to the consumer with the advantages of a low glycemic beverage. In contrast with polyols, isomaltulose advantageously does not have any laxative effect. The isomaltulose surprisingly masks the taste of the protein hydrolysate, which is not perceived as attractive by many consumers, in particular in beverages that have been stored for a long time. Leucrose, like isomaltulose, is a low-glycemic sucrose isomer in comparison with sucrose. In comparison with beverages containing fructose/glucose, functional beverages containing carbohydrate according to the present invention have a low tendency to form Maillard products at the same sweetening level. Finally, the inventive beverage according to the invention has the advantage that the protein hydrolysate is completely soluble and therefore the resulting beverage is clear and stable in the presence of acid.

In an especially preferred embodiment of the present invention, the protein hydrolysate is a casein hydrolysate, especially preferably prepared from casein protein of milk by the action of a protease. In a preferred embodiment, the casein hydrolysate is a casein hydrolysate consisting of short-chain peptides with an average chain length of at most four amino acids, in particular dipeptides and tripeptides. The preferred casein hydrolysate according to the invention is water-soluble.

In a preferred embodiment, it contains all 20 essential amino acids. The amino acid composition of the casein hydrolysate that is especially preferred according to the invention is as follows:

| | PeptoPro ® (casein hydrolysate) | |
|---|---|---|
| Amino acids | mol/kg | g/kg |
| glycine | 0.30 | 22.5 |
| alanine | 0.34 | 30.3 |
| valine | 0.58 | 68.0 |
| leucine | 0.75 | 98.4 |
| isoleucine | 0.40 | 52.5 |
| proline | 0.91 | 104.7 |
| phenylalanine | 0.33 | 54.5 |
| tyrosine | 0.33 | 59.8 |
| tryptophan | 0.07 | 14.3 |
| serine | 0.56 | 58.9 |
| threonine | 0.37 | 44.1 |
| cysteine | 0.06 | 7.3 |
| methionine | 0.23 | 34.3 |
| arginine | 0.22 | 38.3 |
| histidine | 0.21 | 32.6 |
| lysine | 0.58 | 84.8 |
| asparagine aspartic acid | 0.51^{*1)} | 67.4^{*1)} |
| glutamine glutamic acid | 1.54^{*2)} | 225.0^{*2)} |

^{*1)}Value stands for the amount of asparagine and aspartic acid
^{*2)}Value stands for the amount of glutamine and glutamic acid

In another preferred embodiment of the present invention, the liquid medium is water. In another preferred embodiment of the present invention, the beverage contains 0.1 to 20 wt %, preferably 0.3 to 10 wt % protein hydrolysate (each based on the total weight of the beverage). In another preferred embodiment of the present invention, the inventive functional beverage contains 0.1 to 20 wt %, preferably 0.3 to 10 wt % isomaltulose (each based on the total weight of the beverage). In another preferred embodiment of the present invention, the inventive functional beverage contains 0.1 to 20 wt %, preferably 0.3 to 10 wt % leucrose (each based on the total weight of the beverage).

In a preferred embodiment of the present invention, the beverage may be an instant beverage, a beverage containing cola, an enteral solution, a refreshment beverage, a sports beverage, an energy beverage, an isotonic beverage, a soft drink or the like.

Another preferred embodiment of the present invention relates to a functional beverage that contains carbohydrate and additionally contains, for example, food-compatible acids, food-compatible salts, intense sweeteners, minerals, trace elements, fruit extracts, antioxidants, stabilizers, flavoring substances, aroma substances, fragrance substances, another sweetening agent, caffeine, vitamins, lipids or the like.

According to the invention, intense sweeteners that may be used include acesulfame-H, aspartame, stevioside, monelline, cyclamate, sodium cyclamate, sucralose, thaumatine, dulcine, saccharine, neotame, naringine dihydrochalcone, neohesperidine dihydrochalcone, glycyrrhizine or mixtures of two or more of these.

In another preferred embodiment, the beverage contains natural and/or synthetic coloring agents, natural and/or synthetic vitamins, minerals and/or trace elements.

In an especially preferred embodiment of the present invention, the amount of food-compatible acids in the beverage amounts to 0.1 to 10 wt % (based on the total weight of the beverage).

In another preferred embodiment of the present invention, the amount of the intense sweeteners in the beverage is 0.1 to 1 wt % (based on the total weight of the beverage). In another preferred embodiment of the present invention, the amount of flavoring substances, aroma substances, fragrance substances in the beverage is 0.5 to 10 wt % (based on the total weight of the beverage).

In conjunction with the present invention, masking the taste of a beverage containing a protein hydrolysate is understood to mean that, for example, the taste of a composition containing protein hydrolysate which is perceived as unpleasant or bitter by a knowledgeable test subject, for example, in a comparative preparation with a composition containing a protein hydrolysate and a comparative sweetener with statistically relevant importance is perceived to a significantly reduced extent, preferably not at all, if this protein hydrolysate-containing composition in a beverage according to the invention is combined with isomaltulose and/or leucrose instead of the comparative agent. According to the invention, it is preferably provided that the isomaltulose and/or leucrose is used to mask the bitter taste of the composition that contains protein hydrolysate when used in a beverage according to the present invention, i.e., to make the bitter taste imperceptible or unrecognizable and/or detectable to a greatly reduced extent.

In another preferred embodiment, the inventive beverage does not contain any other sugar, in particular no sucrose, no fructose, no tagatose and/or no glucose apart from the isomaltulose and/or leucrose. The isomaltulose and/or leucrose is/are preferably the one and only sugar present in the preparation, in particular the one and only sweetening agent present in the beverage.

In conjunction with the present invention, the term sweetening agent is understood to refer to a substance that has sweetening power and is added to foods or beverages, for example, to produce a sweet taste. In conjunction with the present invention, the sweetening agents are subdivided into sugars, such as isomaltulose, sucrose, glucose or fructose, which impart body and sweetening power on the one hand and “sweeteners” on the other hand, i.e., substances which are not sugars but nevertheless have sweetening power and are in turn subdivided into “sugar substitutes,” i.e., sweetening agents which have body and also have a physiological caloric value in addition to sweetening power (sweeteners that impart body) and “intense sweeteners,” i.e., substances which usually have a very high sweetening power but do not have body and usually have little or no physiological caloric value.

In an especially preferred embodiment, the inventive beverage is gentle on the teeth, noncariogenic and/or dietetic.

However, in another embodiment, it is also possible to provide according to the invention for the isomaltulose and/or leucrose to be used in the beverage together with the intensive sweeteners and/or optionally also sugar substitutes, e.g., isomalt or maltodextrins, lactitol, maltitol, erythritol, xylitol, mannitol, sorbitol, maltitol syrup, starch hydrolysates, 1,1-GPM (1-O-α-D-glucopyranosyl-D-mannitol), 1,6-GPS (6-O-α-D-glucopyranosyl-D-sorbitol) or 1,1-GPS (1-O-α-D-gluco-pyranosyl-D-sorbitol).

Other advantageous embodiments of the present invention are derived from the dependent claims.

1.-20. (canceled)

21. A beverage, comprising:
carbohydrate;
a liquid medium;
casein hydrolysate dissolved in the liquid medium; and
leucrose.

22. The beverage of claim 21, wherein the casein hydrolysate comprises short-chain peptides with an average length of at most four amino acids.

23. The beverage according to claim 21, wherein the liquid medium is water.

24. The beverage according to claim 21, wherein the beverage contains 0.1 to 20 wt % casein hydrolysate based on the total weight of the beverage.

25. The beverage according to claim 21, wherein the beverage contains 0.1 to 20 wt % leucrose based on the total weight of the beverage.

26. The beverage according to claim 25, wherein the beverage contains 0.3 to 10 wt % casein hydrolysate based on the total weight of the beverage.

27. The beverage according to claim 21, wherein the beverage is an instant beverage, a refreshment beverage, a cola beverage, an enteral solution, a sports beverage, an isotonic beverage, an energy beverage or a soft drink.

28. The beverage according to claim 1, wherein the beverage contains at least one of the group consisting of: food-compatible acids, food-compatible salts, minerals, trace elements, fruit extracts, antioxidants, stabilizers, flavoring substances, fragrance substances, vitamins, a malt extract, a sweetening agent and caffeine.

29. The beverage according to claim 21, wherein the beverage contains 0.1 to 10 wt % food-compatible acids based on the total weight of the beverage.

30. The beverage according to claim 21, wherein the beverage contains 0.1 to 1 wt % sweetening agent based on the total weight of the beverage.

31. A beverage, comprising:
a liquid medium;
protein hydrolysate; and
leucrose to improve the taste of the beverage.

32. The beverage of claim 31, wherein the beverage contains between about 0.1 to about 20 wt % leucrose based on the total weight of the beverage.

33. The beverage of claim 31, wherein the beverage contains between about 0.3 to about 10 wt % leucrose based on the total weight of the beverage.

34. The beverage of claim 33, wherein the beverage contains 0.1 to 20 wt % casein hydrolysate based on the total weight of the beverage.

35. A method for improving the taste of a beverage containing casein hydrolysate, comprising:
mixing a liquid medium with a casein hydrolysate to form a beverage; and
mixing leucrose into said liquid medium to mask the flavor of the casein hydrolysate and thereby improve the flavor of the beverage.

36. The method of claim 35, wherein the casein hydrolysate comprises short-chain peptides with an average length of four amino acids or less.

37. The beverage of claim 35, wherein said leucrose comprises between about 0.3 percent and about 10 percent of the total weight of the beverage.

38. The beverage of claim 35, wherein the casein hydrolysate comprises between about 0.1 and 20 percent of the total weight of the beverage.
